(19) United States
(12) Patent Application Publication
(10) Pub. No.: US 2003/0033356 A1
(43) Pub. Date: Feb. 13, 2003

(54) Extensible client aware detection in a wireless portal system

(76) Inventors: Luu Tran, Santa Clara, CA (US); William York, Brighton, CO (US); Jeff Blattman, San Jose, CA (US)

Correspondence Address: WAGNER, MURABITO & HAO LLP, Third Floor, Two North Market Street, San Jose, CA, 95113, US

(21) Appl. No.: 09/929,477

(22) Filed: Aug. 13, 2001

(51) Int. Cl. G06F 15/16

(52) U.S. Cl. 709/203

(57) ABSTRACT

A wireless portal system having a wireless server with an automatic client aware detection mechanism. The client aware detection mechanism includes logic for identifying client wireless devices connected to the wireless server by using particular characteristics of the client in detecting service connection requests from the client to the server. In one embodiment of the invention, the client aware detection mechanism is capable of being extended by the client to add-on client information characteristics which are not already pre-stored in the wireless server. In this way, the client detection logic of the invention is extensible to recognize new devices without requiring software version updates or complex programming tasks. An API can be used to collect extensible data sets that include custom parameters for recognizing a particular client class, such as defined header information of the client's browser, the time of day the client requests are received and the client's bandwidth.

### FIELD OF THE INVENTION

The present claimed invention relates generally to the field of wireless communication systems. More particularly, the present claimed invention relates to client aware file system management in a client independent wireless environment.

### BACKGROUND ART

The Internet has become the dominant vehicle for data communications. And with the growth of Internet usage has come a corresponding growth in the usage of Internet devices, wireless devices and services.

The growing base of Internet users has become accustomed to readily accessing Internet-based services such as e-mail, calendar or content at any time from any location. These services, however, have traditionally been accessible primarily through stationary PCs. However, demand is now building for easy access to these and other communication services for mobile devices.

As the demand for mobile and wireless devices increases, enterprises must roll out new communication capabilities beyond the reach of traditional wired devices, by extending the enterprise with extra-net applications, etc., to effectively and efficiently connect mobile employees with their home base. As the number of digital subscribers grows, traditional wireless providers must find applications suitable to the needs of these new mobile users.

However, service providers are not the only ones seeking applications to meet the growing service needs of wireless users. Traditional portal developers are also extending their traditional PC browser desktop services to these new wireless markets.

With the growth of the wireless market comes a corresponding growth in wireless business opportunities which in today's ever-growing markets means, there is a plethora of services available to customers of the people that use these services. Many wireless service providers are now looking to add to basic core services by extending services such as e-mail, short messaging service notification, and other links to IP-based applications to drive additional business and revenues.

As the wireless market grows and Internet access becomes more mainstream and begins to move to new devices, wireless service providers are looking to develop highly leveraged Internet Protocol based applications on top of existing network infrastructure. To meet the growing demand for wireless client devices, enterprises need to provide access to any type of service from any type of device from anywhere and to provide content suitable for these devices without incurring substantial cost overhead.

The growth in wireless devices also means that traditional computer users who used to be tied to their desktop computers may now be mobile and would require remote access to network applications and services such as email. The mobility of wireless users presents a host of challenges to service providers who may have to provide traditional service to these new wireless devices. One such service is provided by Sun Microsystems, Inc., through its iPlanet™ platform to allow service providers to grow their services from basic traditional services such as voice to leading edge wireless applications with carrier-grade reliability and performance.

In addition to the traditional network applications that these new wireless users seek, the growth of the Internet and the introduction of new Internet enabled wireless devices have led to the explosive use of community-based web sites or portals. The growth in portals has created a need for wireless environments to provide portal support to handle the collection of data related to different topics such as news, stock quotes, applications and services required by wireless device users.

FIG. 1 depicts a prior art wireless client dependent based environment solution to handle similarly configured wireless clients running similar applications or portals. The environment depicted in FIG. 1 includes wireless devices such as a WAP phone 101, a wireless PC 102, a refrigerator 103, etc. In general, the wireless environment depicted in FIG. 1 is categorized into the network (Internet 104), Clients (e.g. mobile phone 101, PCs 102 and household appliances 103) and resources (e.g., web-sites 105, portals 106 and other applications 107).

For most of the wireless clients connected to the Internet 104, portals 106 offer the client the starting point of experiencing the Internet 104. Portals 106 are typically community based web-sites that securely hold a collection of data related to different topics, including such applications as news, stock quotes, etc. For example, a wireless client connecting to the Internet will first login to a web portal site (e.g., yahoo) and from there browse through various sites to search for a host of different services.

The portals typically reside in a portal server which bundles an aggregation of services provided by an Internet service provider and provides these services to wireless clients. A wireless portal server such as that developed by Sun Microsystems, Inc. provides such portal access to wireless application resources residing on resource servers A 108, B 109 and C 110.

The prior art wireless server depicted in FIG. 1 primarily supports the two major types of browsers known by most Internet users. These include the Microsoft Internet Explorer Browser and the Netscape Communicator Browser. These browsers are both Hyper Text Markup Language (HTML) based and suitable for some wireless devices, especially devices with large display screens. However, as wireless display screens get smaller in size, traditional HTML browsers are no longer suitable for transmitting content to these wireless devices.

To ensure suitable content delivery, wireless device and wireless software providers have developed a myriad of micro-browsers which appropriately adapt to these wireless devices with different display screen requirements in order to take advantage of the numerous content on the Internet. The availability of these new micro-browsers means that service providers do not have to create different sets of content for different wireless devices even if the devices are dissimilar.

The support of primarily only two major types of browsers is a drawback because it does not allow the wireless server to identify and recognize a myriad of today's micro browsers such as those used by a host of wireless phones and other handheld devices other than the two major types. This restricts the number of wireless client devices which may be connected to the server.

In the prior art wireless environment depicted in FIG. 1, clients requesting services to the wireless environment are identified by the server by one of two ways. The first is by way of predefined, pre-configured device types which are stored in the server and enable the server to identify clients trying to connect to it The second method of detection is by way of a complex tool-kit which is typically sold with the wireless clients. In the case of the tool-kit approach, the end-user has the burden to program the client in order for the wireless server to identify the client during a connection session to the server.

Either one of these prior art detection schemes have some drawback. In the first detection scheme, the wireless server is unable to identify device types which are not pre-defined and stored in the server. An entire software upgrade is required to recognize new client types. And in the second scheme, the end-user requires technical software programming expertise to be able to program the tool-kit to enable detection and use of the wireless server resources.

Another drawback of the prior art system as shown in FIG. 1, is that most of the servers are designed to identify clients using the least common characteristics of known clients. For example, a server which is designed to recognize wireless phones will have as the least common identifier the phone characteristics common to all the identifiable phones which will be used to identify service request to the wireless environment. Thus, if two wireless phones exist of the same manufacturer, but with two dissimilar screen requirements (e.g., 4 line text display vs. 8 line text display), then the server will be designed to support wireless phones by that manufacturer as requiring only 4 line text display (least common characteristic).

The discrepancies between display information on the two phones in this example becomes very pronounced if one considers the fact that the phone requiring an 8 line text display loses 50% of its display capabilities. Thus, the client is unable to take advantage of the full richness such as the look and feel features of the client interface with the end-user, the scripting behavior of the interface, etc.

A further drawback of the wireless server of the prior art is that most of the servers are designed to identify wireless clients using HTML as the default identifier. Thus, a client running any other Internet language will not be identified and therefore denied services, or given incompatible content

### SUMMARY OF INVENTION

Accordingly, to take advantage of the myriad of applications and the numerous wireless clients being developed, a wireless server with extensibility capabilities to allow wireless clients to be dynamically configured and identified by the wireless server is needed. A need exists for “out-of-the-box” wireless system solutions to allow technically inept end-users to connect to the wireless environment without unduly tasking the end-user's technical abilities. A need further exists for an improved and less costly device independent system which improves efficiency and identification of various wireless clients without losing the embedded features designed for these devices.

The present invention is directed to a system and a method for identifying wireless clients in a client independent wireless system. The present invention is capable of handling both voice and data transmission over an Internet protocol local access network within wireless systems without the losing inherent characteristics of the client when it connects to a wireless server within the wireless system to request services.

Embodiments of the invention include pluggable Client Detection Modules which provide automatic and extensible client identification using characteristics of the client as unique identifiers by the wireless server to provide services. The client characteristics may or may not be known to the wireless server at the time a client attempts to connect to the server. An Application Program Interface (API) is used which can assist newly created “out-of-the-box” detection modules to add detection support to the server.

Embodiments of the present invention further include client extensible logic which allows the wireless client to dynamically add additional characteristics to any defaults that might be stored in the wireless server to enable the server to identify the client as the client attempts to connect to the server. In this way, the client detection logic of the invention is extensible to recognize new device classes without requiring software version updates or complex programming tasks. An API can be used to collect extensible data sets that include custom parameters for recognizing a particular client class, such as defined header information of the client's browser, the time of day the client requests are received and the client's bandwidth.

Embodiments of the present invention further include a User Agent information decipher which is coupled to parse client request HTTP headers. The User Agent information is parsed to identify wireless client type information to enable the wireless server to provide the appropriate services to identified clients connected to the system.

These and other objects and advantages of the present invention will no doubt become obvious to those of ordinary skill in the art after having read the following detailed description of the preferred embodiments which are illustrated in the various drawing figures.

### BRIEF DESCRIPTION OF THE DRAWINGS

The accompanying drawings, which are incorporated in and form a part of this specification, illustrates embodiments of the invention and, together with the description, serve to explain the principles of the invention:

Prior Art FIG. 1 is a block diagram of a conventional device dependent wireless system;

FIG. 2 is a block diagram of an implementation of a device independent wireless system of the present invention;

FIG. 3 is a block diagram of an exemplary internal architecture of the wireless server of FIG. 2;

FIG. 4 is a block diagram of an embodiment of the client aware detection system of the present invention; and

FIG. 5 is a flow diagram of an embodiment of the client detection logic of the present invention.

### DESCRIPTION OF THE PREFERRED EMBODIMENTS

Reference will now be made in detail to the preferred embodiments of the invention, examples of which are illustrated in the accompanying drawings. While the invention will be described in conjunction with the preferred embodiments, it will be understood that they are not intended to limit the invention to these embodiments.

On the contrary, the invention is intended to cover alternatives, modifications and equivalents, which may be included within the spirit and scope of the invention as defined by the appended Claims. Furthermore, in the following detailed description of the present invention, numerous specific details are set forth in order to provide a thorough understanding of the present invention. However, it will be obvious to one of ordinary skill in the art that the present invention may be practiced without these specific details. In other instances, well known methods, procedures, components, and circuits have not been described in detail as not to unnecessarily obscure aspects of the present invention.

The invention is directed to a system, an architecture, subsystem and method to manage wireless client detection in a client independent wireless environment in a way superior to the prior art In accordance with an aspect of the invention, a wireless server provides wireless client extensibility which enables non predefined devices to be identified by the wireless server.

In the following detailed description of the present invention, a system and method for a wireless Internet protocol based communication system is described. Numerous specific details are not set forth in order to provide a thorough understanding of the present invention. However, it will be recognized by one skilled in the art that the present invention may be practiced without these specific details or with equivalents thereof.

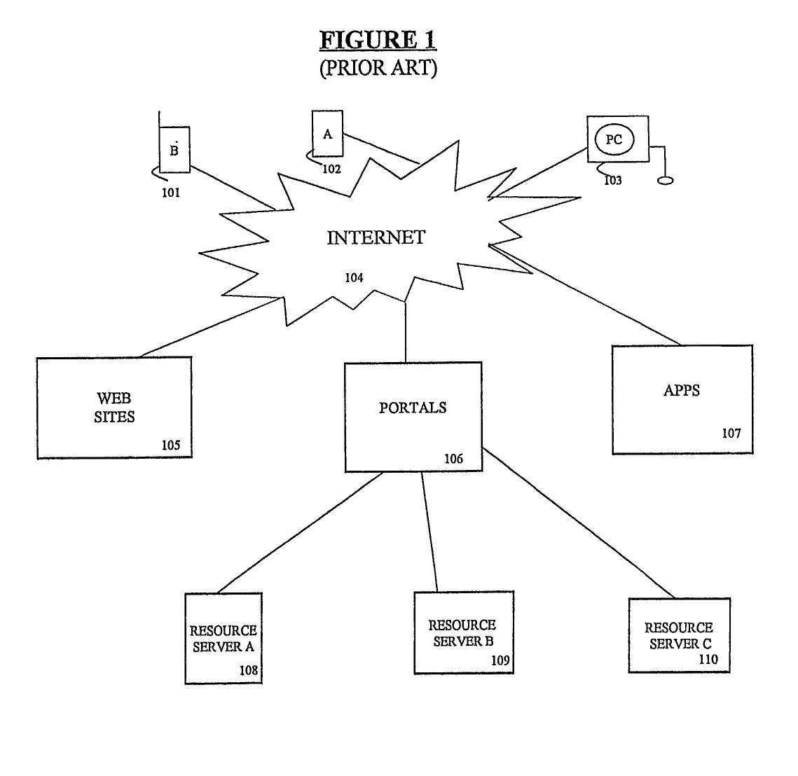

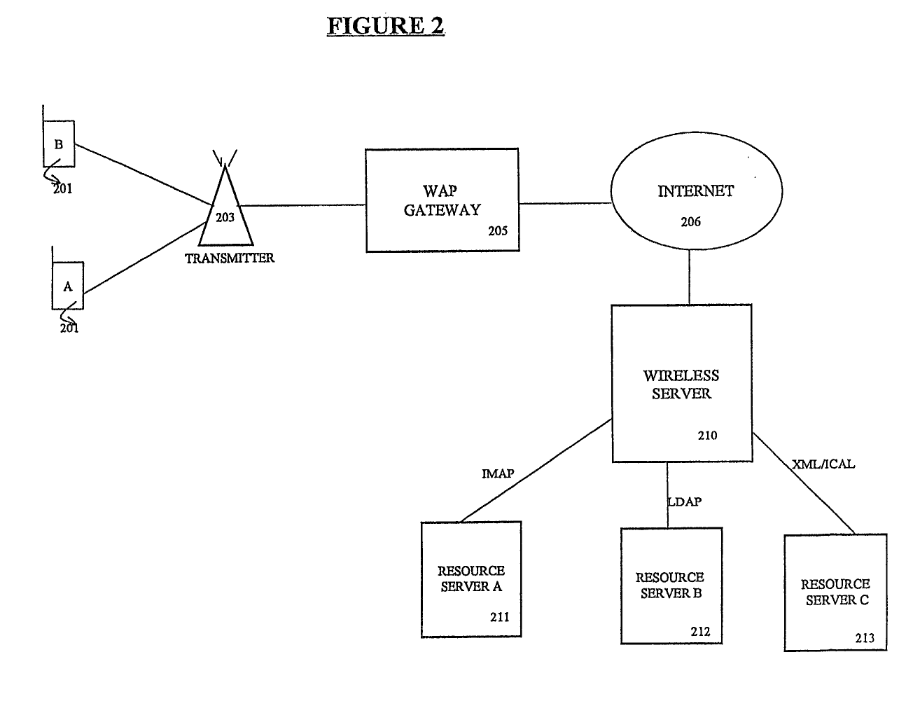

Generally, an aspect of the invention encompasses providing an integrated wireless Internet server which provides a wide range of voice, data, video and other services to wireless clients which may connect to the wireless environment to be serviced alongside predefined wireless clients. The invention can be more fully described with reference to FIGS. 2 through 5.

FIG. 2 depicts an embodiment of the wireless device independent based environment of the present invention. The wireless environment depicted in FIG. 2 comprises a wireless application protocol (WAP) based phone, a WAP transmission infrastructure 203, a WAP gateway 205, the Internet 206 and a wireless server 210. In a Global Switch Mobile network for instance, when the phone transmission is received by the mobile switching center, it realizes it is packet data and sends it to the proper channel to be processed. The WAP gateway 205 typically resides on the Local Area Network (LAN) within a telecom carriers premises. It is not generally a part of the wireless server. The WAP gateway 205 is responsible for connecting the Wireless Markup Language/HTTP content and protocol into a bundled compressed, encoded, encrypted version of WML over WAP.

Conversely, the WAP gateway 205 also performs the translation of WAP commands into HTTP requests which can be sent over the public Internet. The WAP gateway 205 can also store user's bookmarks, two of which could point to the wireless server's messaging and other resource services. The wireless server 210 communicates WML over HTTP on the front -end and communicates in native protocol of the target server on the back-end.

The wireless server 210 communicates to these back-end resource servers using the backend server's native protocol. For example, the wireless server may communicate to resource server A which may be a messaging server using Internet Message Access Protocol (IMAP). A Lightweight Directory Access Protocol (LDAP) is used for all communications to and from the resource server B. And an extensible markup language Q(ML) protocol may be used to communicate with resource server C.

Although the wireless server depicted in FIG. 2 is capable of communicating in these native protocols shown in FIG. 2, the wireless server protocol's handling capability can be extended to support other protocols. The wireless server implements the Wireless Markup Language (WML) interface and generates the corresponding WML content based on what it receives from the back-end server.

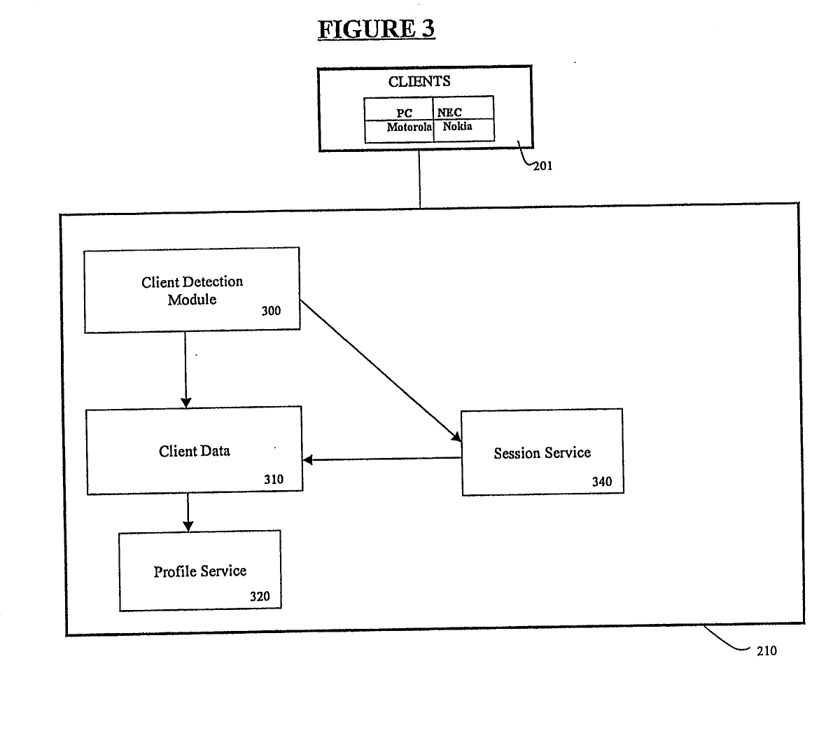

FIG. 3 is a block diagram illustration of one embodiment of the wireless system of the present invention. The wireless system shown in FIG. 3 includes a Wireless Server 210 (WS) and Wireless Clients 200. The WS 210 includes Client Detection Module (CDM) 300, Client Data (CD) module 310 which couples to CDM 300, Profile Service (PS) module 320 which couples to CD 310 and Session Service (SS) module 340. WS 210 may include other modules which have not been disclosed here in order not to confuse the teachings of the present invention.

The wireless server 210 shown in FIG. 3 is flexible, scalable, extensible and capable of supporting a rich evolving range of networks such as Global system for mobile communication (GSM) Networks, Code Division Multiple Access (CDMA) Networks, Time Division Multiple Access (TDMA) Networks, Third Generation (3G) Networks and others.

The architecture of the server is also capable of handling a variety of wireless environments and markup languages such as the wireless markup language (WML), the handheld device markup language (HDML) and the hypertext markup language (HTML). The server 210 is capable of providing support for multiple devices and is easily adaptable and extensible to additional devices and markup languages.

CDM 300 receives client service request to WS 210 via a client detection software API CDM 300 determines the clients device characteristic such as content-type, template directory, etc. Unlike the prior art, CDM 300 does not assume a client request to only emanate from HTML based devices and is therefore capable of identifying a host of micro-browsers used by a number of wireless clients.

The client type information gathered by the CDM 300 in the present invention may include the client's browser type, version number and underlying Operating System supporting the browser. The client type information may further include the client's bandwidth information, time of the day the client is allowed to receive certain services by the content provider (e.g., real time stock quotes, etc.), client's location, etc. All of this information can be used by the CDM 300 to automatically detect the client type.

Client data extracted by CDM 300 is passed to CD 310 which stores client data objects of various properties of the client, such as user-agent matching pattern, acceptable response content-type, cookie support status, etc. Unlike the prior art, CD 310 relies on other characteristics of a client's request information for storage rather than assuming that any client request information represented a generic HTML device. Furthermore, in the present invention, CD 310 is readily extensible to enable additional attributes of a client connecting to WS 210 to be dynamically added as needed.

SS module 340 stores transient information pertaining to a user's active session with the client device when the client initiates a service request to the server. A new session property is defined to store a clientType identifier after the client has been detected by the Wireless Server 210.

CDM 300 performs automatic client detection based on header information contained in the client's browser, (e.g., name of browser, version, operating system supported by the browser, hardware descriptions, etc.), the time of day the client request is received and the bandwidth of the client's communication. These and other factors are aggregated together and considered by the CDM 300 during its automatic detection processes.

Importantly, the CDM 300 requires data modules for performing individual client type detection. These data modules are extensible so that new detection can be added for header type information, bandwidth information, time of day information, which all can be used to recognize a particular new client type.

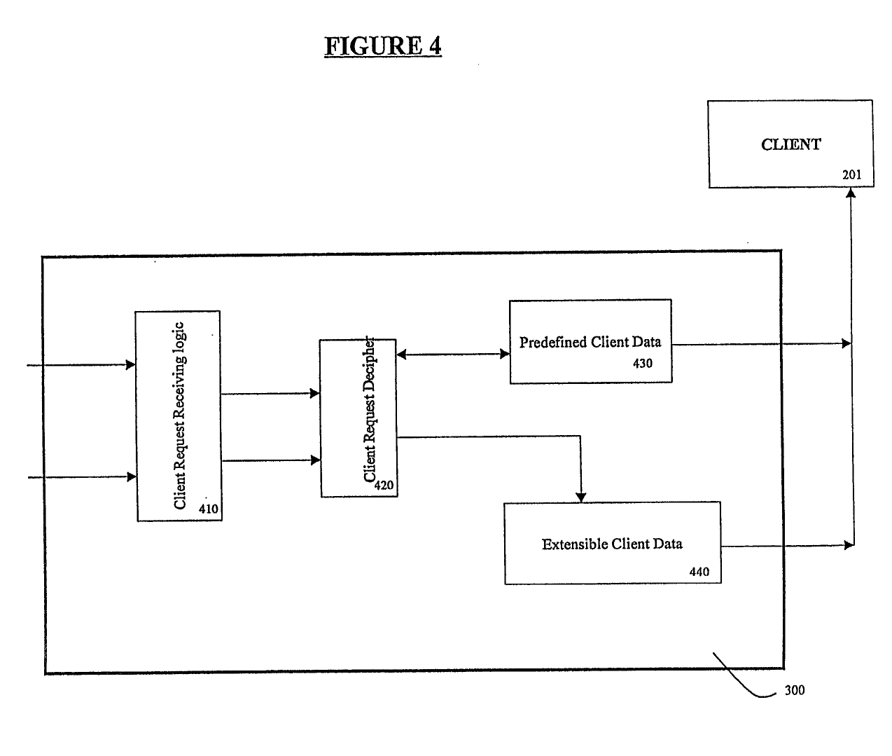

Referring to FIG. 4, a block diagram illustration of one embodiment of the Client Detection Module (CDM) 300 is shown. CDM 300 comprises a client request receiving logic (CRRL) unit 410, a client request processing logic (CRP) 420, Predefined Client Data Logic (PCD) 430 and Extensible Client Data (ECD) 440.

All client service requests made to the WS 210 from clients connected to the wireless network are passed to CRRL 410. When a client initiates a service request, the request is forwarded to CRRL 410. Each client service request includes header information from which CRRL 410 is able to extract the necessary client characteristics to process the request. When CRRL 410 receives the client's initial request, it parses the HTTP header to get the User Agent (UA) information. The parsed information is then passed on to the CRL 420. CRRL 410 may also use other headers apart form the user-agent headers to extract the client-type information.

CRL 420 couples to CRRL 410 to process the UA information received from the client request HTTP headers. Embedded in each UA is information which specifies the client device type. If the UA indicates a device type which matches known client types (predefined clients), CRD 420 executes a call to PCD 430 and attempts to find a match for user agents. If a match is determined by PCD 430, the client is connected to an authenticating servers of the server 210 and provided with the service being requested. For example, if the UA indicates that the device is a WAP phone, the appropriate Client type identifier is stored in session for the client.

Based on the stored Client type identifier, the server knows which method to invoke to provided the requested service. In addition to the UA, CRD 420 can look at other headers of the client request, such as the time of day (e.g., time of day the client can have access to certain services in the wireless environment as defined by the service provider), the user making the request and other information that may be gathered from the client's environment in determining what services to provide the client in response to the client's request.

If no known device type is found by CRD 420, a call is executed to ECD 440 to extend the current data objects stored in the server; thereby effectively creating a subclass and overriding certain predefined methods in the server. This functionality is extremely important since many wireless devices have unique interfaces and do not follow a common implementation standard, it is critical for a WML generation engine in WS 210 to be flexible and extensible to add these new devices. Extensibility in the present invention is achieved by implementing API level additions by the content server provider, who provide services to the wireless clients, to add environmental characteristics to uniquely identify and distinguish a class of clients from others. The extensible API could also be programmed by a system developer from run-time information gathered from the client.

Since WS 210 knows about the differences between various wireless devices, e.g., differences between WAP phones or differences between phone and Palm browsers, etc. CRD 420 does not need to know the differences between devices. It only needs to present the client characteristics provided by the client to be processed in WS 210.

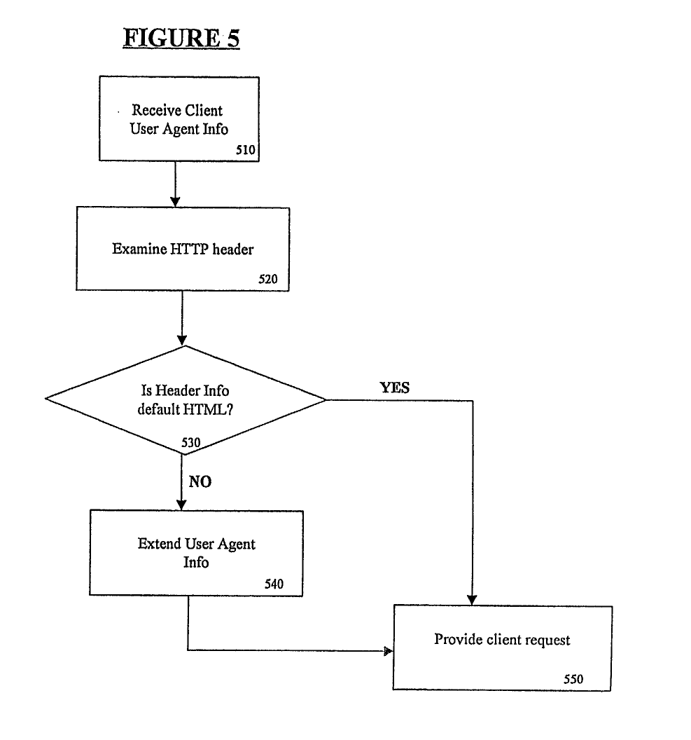

Referring now to FIG. 5, a logic flow diagram of one embodiment of the client detection scheme of the present invention is shown. A client initiates service request to initiate the detection scheme at step 510.

At step 520, the client detection module examines the HTTP header from the client request using the client data API to access the client data objects to find a suitable match.

At step 530, if the client device type information included in the user agent information matches, CDM 300 returns a unique identifier (clientType) of the matching client data object and the client type information is presented to the session service logic at step 550. In the present invention, clientType defines a logic group of clients uniquely identified by an extensible list of properties. Two devices that are of the same clientType can be treated as identical as far as how the server should respond to their requests.

On the other hand, if the client type in the UA is not a match in the client data objects, the client type information is added to extend the current WMNL object class and processing ends at step 540 and the client type information is provided to the session service at step 550.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications are suited to the particular use contemplated. It is intended that the scope of the invention be defined by the Claims appended hereto and their equivalents.

1. A wireless network environment, comprising:
a plurality of classes of wireless clients, each class of wireless clients having unique identifiers and attributes independent of other classes of wireless clients within the wireless network environment; and
a wireless client independent wireless server coupled to communicate with said classes of wireless clients to provide a series of services available on said server, said classes of wireless clients issuing service requests to the wireless server via established communication links and protocols within the network; and
wherein one of said services comprise automatic client type detection using extensible parameters.

2. The wireless network environment of claim 1, wherein said automatic client detection comprises client aware detection logic for automatically detecting client specific attributes from service requests issued to said wireless server from a wireless client within any of the classes of wireless clients.

3. The wireless network environment of claim 2, wherein said wireless server further includes a wireless client data storage logic coupled to said wireless detection logic to store client data objects which uniquely define each client within said class of clients.

4. The wireless network environment of claim 2, wherein said client detection logic detects clients specific attributes of a wireless client seeking services from the wireless server by examining the hypertext transport protocol header from the client's request.

5. The wireless network environment of claim 2, wherein said client detection logic comprises client data distinguishing logic for distinguishing between predefined client information pertaining to a client within any of said classes of wireless clients stored in said client data storage logic and client data information which is dynamically extracted by said client detection logic.

6. The wireless network environment of claim 4, wherein said client detection logic is extensible to dynamically gather client specific information as said client issues service requests to said wireless server.

7. The wireless network environment of claim 6, wherein said client detection logic extracts client specific attributes from said client's user-agent Hyper Text Transport Protocol header from the client's request to the wireless server.

8. The wireless network environment of claim 7, wherein said client detection logic extracts client specific attributes from headers other than the user-agent header in the client's Hyper Text Transport Protocol request.

9. A wireless server for handling a plurality of wireless service requests from a plurality of wireless clients each having unique identifying attributes, said wireless server comprising:
a wireless extensible client aware detector;
a wireless client data storage coupled to said extensible wireless client aware detector; and
a wireless server session service coupled to said extensible wireless client aware detector.

10. The wireless server of claim 9, wherein said wireless client detector is capable of extracting client specific data to uniquely identify wireless clients requesting services from said wireless server.

11. The wireless server of claim 10, wherein the wireless client detector comprises logic to differentiate predefined data pertaining to a particular wireless clients stored in the wireless server from client specific data dynamically extracted at client run-time.

12. The wireless server of claim 11, wherein the wireless client data storage stores client predefined data objects for a known class of wireless clients which connect to the wireless server.

13. The wireless server of claim 11, wherein the client aware detector comprises client request deciphering logic for parsing client service request headers to determine whether data pertaining to a specific client requesting service from the wireless server is already available in the wireless server or not.

14. The wireless server of claim 13, wherein the client aware detector further comprises client data extensible logic for dynamically extracting clientType information which is not already stored in the wireless server from the client request headers.

15. The wireless server of claim 14, wherein said clientType information defines a logical group of clients uniquely identified by an extensible list of properties common to the group.

16. A wireless server system, comprising:
a plurality of extensible definition files, each definition file for providing detection for a class of wireless clients that communicate with said wireless server system; and
an automatic detection system, coupled to access said plurality of extensible definition files, for applying a particular definition file to a particular wireless client for automatically detecting the class of said particular wireless client, wherein said particular definition file comprises information found within a service request of said wireless client that allows said detecting thereof.

17. The wireless server system of claim 16, wherein said automatic detection system is rendered capable of recognizing a new client class by the addition of a corresponding new definition file to said plurality of extensible definition files.

18. The wireless server system of claim 16, wherein said information found within said service request includes information found within an agent header of said service request.

19. The wireless server system of claim 16, wherein said information found within said service request comprises the time of day of said service request.

20. The wireless server system of claim 16, wherein said information found within said service request comprises communication bandwidth of said service request.

21. The wireless server system of claim 18, wherein said information found within said service request further comprises the time and date of said service request.

22. The wireless server system of claim 21, wherein said information found within said service request further comprises communication bandwidth of said service request.

23. A client aware method of detecting wireless clients within a wireless network attempting to connect to a wireless server, comprising the steps of:
receiving client service requests from a plurality of clients connecting to the wireless server; and
parsing header information in said wireless client service requests to automatically extract client specific information and comparing said client specific information to extensible parameters in order to detect said wireless client that is attempting to connect to said wireless server.

24. The method of claim 23, wherein the information extracted from said wireless client service requests may be information common to a group of clients within said plurality of wireless clients.

25. The method of claim 23, further including a step of dynamically adding new parameters extracted from the wireless clients service requests to detect said clients by the wireless server.

26. The method of claim 24, wherein user-agent header information is parsed to detect the characteristics of the wireless client connecting to said wireless server.

27. The method of claim 24, wherein header information other than user-agent headers is extracted from said wireless client service request to detect the wireless client connecting to said wireless server.

28. The method of claim 23, wherein said extensible parameters comprise definitions found in header information of a client's browser.

29. The method of claim 28, wherein said extensible parameters further comprise definitions of time of day requests and client communication bandwidth of a client.
